(19) United States
(12) Patent Application Publication
(10) Pub. No.: US 2026/0221313 A1
(43) Pub. Date: Jul. 30, 2026

(54) CABLE HARNESS AND METHOD FOR ITS MANUFACTURE

(71) Applicant: AUDI AG, Ingolstadt (DE)

(72) Inventor: Markus STÖRMER, Berching (DE)

(21) Appl. No.: 19/462,878

(22) Filed: Jan. 28, 2026

(30) Foreign Application Priority Data
Jan. 29, 2025 (DE) 102025103093.6

(51) Int. Cl. H01B 7/00; B60R 16/02

(52) U.S. Cl. CPC H01B 7/0045; B60R 16/0215

(57) ABSTRACT

A cable harness with at least one electrical conductor is provided which has an electrically conductive core conductor, an electrically non-conductive sheath surrounding the respective electrically conductive core conductor on an outer circumference thereof, and an electrically conductive conductor shield surrounding the electrically non-conductive sheath; at least one electrically conductive plate which has at least one insertion hole through which the electrical conductor is routed, a first projection which projects from an edge of the insertion hole, at least one fastening hole for receiving a fastener by way of which the plate is able to be fastened to an object, and a second projection which projects from an edge of the fastening hole; at least one fastening element which fastens a section of the conductor shield folded over to an outer circumferential surface of the first projection to the first projection; and a plastic body which encloses the at least one electrically conductive plate on an outside thereof, wherein the outer circumferential surface of the first projection and a region of the second projection protrude from the plastic body. A method for manufacturing a cable harness is also provided.

### BACKGROUND

### Technical Field

The disclosure relates to a cable harness and a method for its manufacture.

### Description of the Related Art

A cable harness is usually a bundling of individual cables or lines that transmit signals (information) or working currents (energy).

A plurality of cables can be combined into a cable harness according to design specifications and routed as a cable harness, which is held together, for example, by a sheath, clamps, cable ties, twine or hoses. This harness, which has only limited flexibility, is then installed in a vehicle, for example.

Cable harnesses are usually assembled according to geometric and electrical requirements.

In electrical engineering, various cables and lines are shielded in a generally known manner. A shield current generated in a conductor shield can be transmitted via a plug of the cable, for example to a housing to which the plug of the cable is connected.

A cable harness with a plurality of shielded cables whose conductor shields are connected to a common metal plate of a plug is known, for example, from US 2021/0125742 A1. The metal plate can be screwed to a housing via fastening holes.

A cable harness with a similar structure is also known from US 2023/0022337 A1.

### BRIEF SUMMARY

Against this background, the disclosure provides a cable harness and a method for its manufacture which enable simplified, efficient and cost-effective manufacture and assembly.

It should be noted that the features listed individually in the claims can be combined with each other in any technically meaningful way (even across category boundaries, for example between method and device) and show further designs of the disclosure. The description additionally characterizes and specifies aspects or embodiments of the disclosure, in particular in connection with the figures.

It should also be noted that a conjunction “and/or” used herein between two features and linking them together should always be interpreted such that only the first feature may be present in a first design of the subject matter according to the disclosure, only the second feature may be present in a second design, and both the first and second features may be present in a third design.

The subject matter of the disclosure is a cable harness which has at least one electrical conductor which in turn has an electrically conductive core conductor, an electrically non-conductive sheath surrounding the respective electrically conductive core conductor on the outer circumference and an electrically conductive conductor shield surrounding the electrically non-conductive sheath on the outer circumference. Furthermore, the cable harness has at least one electrically conductive plate which has at least one insertion hole through which the electrical conductor is routed, a first projection which projects from an edge of the insertion hole, at least one fastening hole for receiving a fastener by way of which the plate can be fastened to an object (e.g., a housing), and a second projection which projects from an edge of the fastening hole.

It should be understood that the fastener and the object to which the cable harness is to be fastened are not components of the cable harness according to the disclosure and do not restrict it.

The cable harness also has at least one fastening element that fastens a section of the conductor shield that is folded over to an outer circumferential surface of the first projection to the first projection. Furthermore, the cable harness has a plastic body which encloses the at least one electrically conductive plate on the outside, wherein the outer circumferential surface of the first projection and a region of the second projection protrude from the plastic body.

In other words, the electrically conductive plate is embedded (e.g., molded) into the plastic body, i.e., the narrow and wide sides of the plate are suitably enclosed by the plastic body. In contrast, a part of the first projection and a part of the second projection are not enclosed by the plastic body. In the sense of the disclosure, they thus protrude from the plastic body. However, a spatial projection relative to a surface of the plastic body is not absolutely necessary.

It should be understood that the first and the second projection are each electrically conductive and electroconductively connected to the plate. In this way, the conductor shield is electroconductively connected to the electrically conductive plate via the first projection. Since the second projection projecting from the edge of the fastening hole is not enclosed by the plastic body, the second projection provides a contact surface for the fastener that can be accommodated in the fastening hole. If the fastener is electrically conductive, it automatically establishes an electrically conductive connection to the object, which can be a housing, for example, to which the cable harness or the electrically conductive plate is to be fastened by way of the fastener. The object can be electrically conductive in order to absorb a shield current conducted in the conductor shield and, if necessary, also discharge it (e.g., to earth).

The electrically conductive plate can be substantially completely enclosed by the plastic body except for the outer circumferential surface of the first projection and the region of the second projection, thus protecting it from external influences (e.g., corrosion). The manufacture of the cable harness is simplified. The electrically conductive plate can be provided enclosed by the plastic body as a prefabricated component to which the at least one conductor and its conductor shield are fastened in one assembly step as described herein. The manufacture of the cable harness can be performed efficiently and cost-effectively. The cable harness assembled in this way enables efficient assembly, e.g., in a vehicle.

In an advantageous embodiment, the first projection is formed integrally with the electrically conductive plate.

In a further advantageous embodiment, the second projection may be formed integrally with the electrically conductive plate.

In both of the aforementioned embodiments, the electrically conductive plate can be provided in a structural unit with the first and/or the second projection, thereby further simplifying the manufacture and assembly of the cable harness.

Other embodiments provide for the cable harness to have a plurality of electrically conductive plates. This means that each individual plate has at least the insertion hole with the first projection and at least the fastening hole with the second projection. In this case, the plastic body encloses all the conductive plates, wherein the respective outer circumferential surfaces of the first projections and the respective regions of the second projections protrude from the plastic body. The plastic body holds the individual electrically conductive plates in a desired arrangement relationship.

If the plastic body is not electrically conductive, the individual electrically conductive plates are arranged in the plastic body electrically insulated from each other. Advantageously, this can be used to implement special shielding concepts.

Alternatively, the plastic body can be designed to be electrically conductive. In the case of a plurality of electrically conductive plates, the plastic body creates an electrically conductive connection between the individual plates.

In a further advantageous embodiment, the second projection is designed in the form of a sleeve. The second projection can act as a support sleeve to support the electrically conductive plate between the fastener (e.g., a screw or a rivet) and the object to which the cable harness is to be fastened, and at the same time establish the electrically conductive connection to the object.

Other advantageous embodiments may provide for an end face of the sleeve-shaped second projection to be flush with a surface of the plastic body, which allows for an even more compact design of the cable harness.

Another subject matter of the disclosure is a method for manufacturing a cable harness, which comprises:

providing at least one electrical conductor which has an electrically conductive core conductor, an electrically non-conductive sheath surrounding the respective electrically conductive core conductor on the outer circumference and an electrically conductive conductor shield surrounding the electrically non-conductive sheath on the outer circumference,

providing at least one electrically conductive plate having at least one insertion hole, a first projection which projects from an edge of the insertion hole, at least one fastening hole for receiving a fastener by way of which the plate can be fastened to an object, and a second projection which projects from an edge of the fastening hole,

enclosing the at least one electrically conductive plate on the outside with a plastic material to form a plastic body in such a way that an outer circumferential surface of the first projection and a region of the second projection protrude from the plastic body,

inserting the electrical conductor into the insertion hole,

folding a section of the conductor shield towards the outer circumferential surface of the first projection, and

providing at least one fastening element and fastening the section of the conductor shield folded over towards the outer circumferential surface of the first projection to the first projection.

It is to be understood that with regard to method-related definitions of terms and the effects and advantages of method-related features, it can be fully relied upon the disclosure of analogous definitions, effects and advantages of the cable harness according to the disclosure, and vice versa. A repetition of discussions of analogous features, their effects and advantages can thus be dispensed with in favor of a more compact description, without such omissions being to be interpreted as a limitation for any of the disclosed subject matter of the disclosure.

In an advantageous embodiment, enclosing the at least one electrically conductive plate with the plastic body involves overmolding the plate with a plastic material.

In another embodiment, fastening of the conductor shield to the first projection is performed by crimping. Crimping is a joining process in which the conductor shield is fastened to the first projection by plastic deformation of the fastener and/or the outer circumferential surface of the first projection, for example by flanging, crimping or folding.

Further advantageous embodiments provide for the provision of a plurality of electrical conductors, a plurality of fastening elements and a plurality of electrically conductive plates, wherein the plurality of plates are jointly enclosed on the outside with the plastic material to form the plastic body, wherein one of the plurality of conductors is inserted into the at least one insertion hole of each plate and the conductor shield of the respective conductor is fastened to the corresponding first projection of the respective plate by way of at least one of the fastening elements. All electrically conductive plates are thus arranged and held in a single plastic body.

### BRIEF DESCRIPTION OF THE SEVERAL VIEWS OF THE DRAWINGS

Further features and advantages of the disclosure are apparent from the following description of non-limiting embodiments of the disclosure, which are discussed in more detail below with reference to the drawing. This drawing shows schematically:

FIG. 1 is a perspective view of a part of a cable harness according to one embodiment of the disclosure;

FIG. 2 is a perspective sectional view through a component of the cable harness from FIG. 1;

FIG. 3 is a perspective sectional view through a component of a cable harness according to a further embodiment of the disclosure;

FIG. 4 is a perspective view of a component of the cable harness from FIG. 1 after a first step of a method according to an embodiment of the disclosure;

FIG. 5 is a perspective view of the component from FIG. 4 after a further step of the method;

FIG. 6 is a perspective view of the component from FIG. 5 after a further step of the method;

FIG. 7 is a perspective longitudinal sectional view of the component from FIG. 6 after a still further step of the method; and

FIG. 8 is a perspective longitudinal sectional view of the component from FIG. 7 after a further step of the method.

### DETAILED DESCRIPTION

In the various figures, parts that are equal in terms of their function are always provided with the same reference signs so that they are generally only described once.

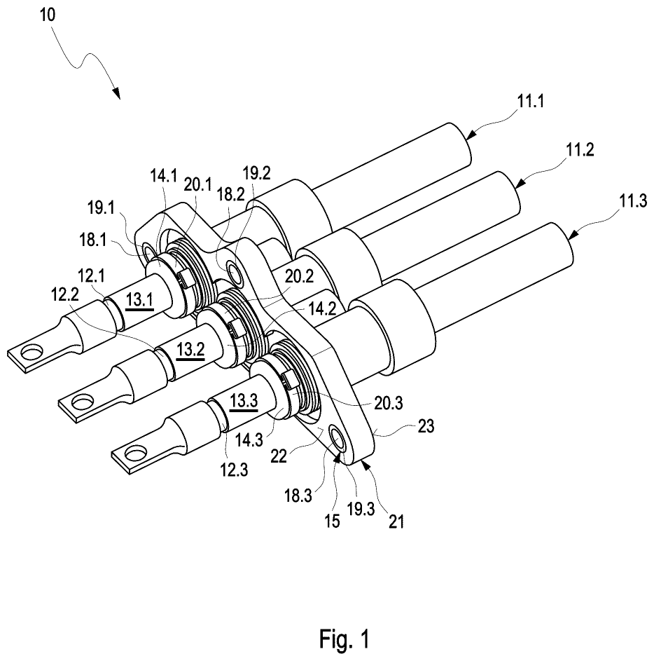

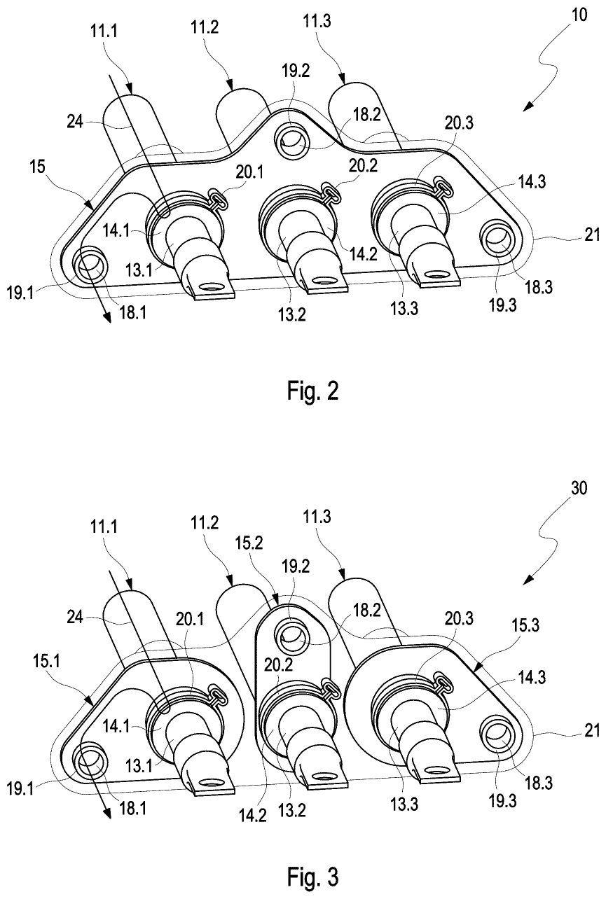

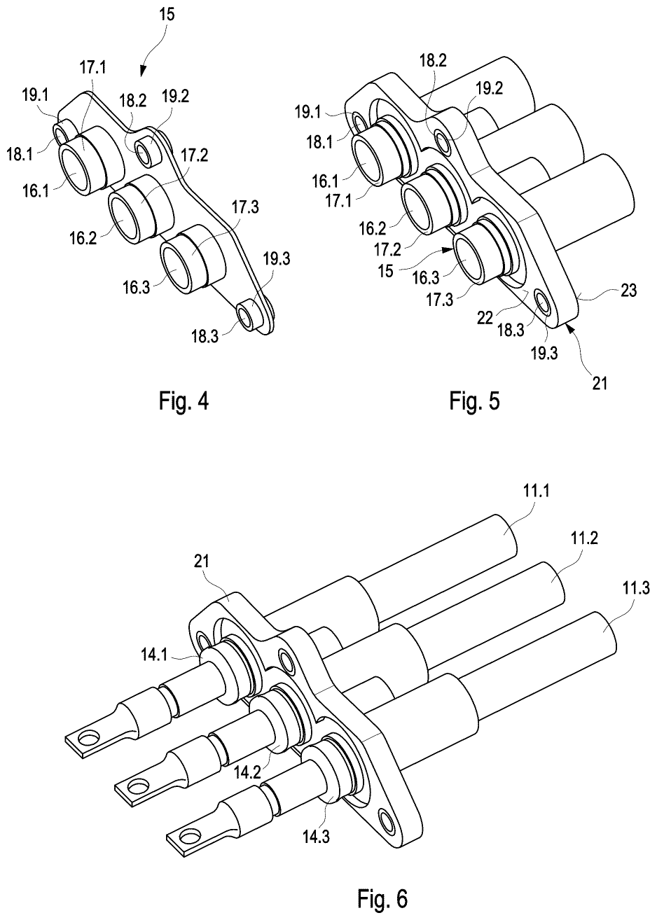

In the following, reference is made simultaneously to FIGS. 1, 2, 4 and 5, wherein FIG. 1 schematically depicts a perspective view of a part of a cable harness 10 according to one embodiment of the disclosure, FIG. 2 depicts a perspective sectional view through a component of the cable harness 10 from FIG. 1, FIG. 4 depicts a perspective view of a component of the cable harness 10 from FIG. 1 after a first step of a method according to one embodiment of the disclosure, and FIG. 5 depicts a perspective view of the component from FIG. 4 after a further step of the method.

In the present example, the cable harness 10 has three electrical conductors 11.1, 11.2 and 11.3. The disclosure is of course not limited to the number of conductors shown. The cable harness can have more or less than the three conductors 11.1, 11.2, 11.3 shown.

Each conductor 11.1, 11.2 and 11.3 has an electrically conductive core conductor 12.1, 12.2 or 12.3, an electrically non-conductive sheath 13.1, 13.2 or 13.3 surrounding the respective electrically conductive core conductor 12.1, 12.2, 12.3 on the outer circumference, and an electrically conductive conductor shield 14.1, 14.2 or 14.3 surrounding the electrically non-conductive sheath 13.1, 13.2, 13.3 on the outer circumference.

The cable harness 10 also has an electrically conductive plate 15 (e.g., a metal plate). This plate 15 in turn has insertion holes 16.1, 16.2 and 16.3 for each of the conductors 11.1, 11.2 and 11.3 respectively. As can be seen in FIG. 1, for example, the conductors 11.1, 11.2 and 11.3 are routed through the corresponding insertion hole 16.1, 16.2 and 16.3 respectively. Furthermore, the plate 15 in the present case has three first projections 17.1, 17.2 and 17.3, each of which projects from an edge of the corresponding insertion hole 16.1, 16.2 and 16.3 respectively. In addition, the plate 15 in the present case has three fastening holes 18.1, 18.2 and 18.3. These fastening holes are used to accommodate a fastener which is not depicted (e.g., a screw, a rivet or similar), by way of which the plate 15 can be fastened to an object (e.g., a housing) that is also not depicted. Finally, the plate 15 in the present case has three second projections 19.1, 19.2 and 19.3, each of which projects from an edge of the respective fastening hole 18.1, 18.2 and 18.3.

In the present case, the cable harness 10 furthermore has three fastening elements 20.1, 20.2 and 20.3, which each fasten a section of the conductor shield 14.1, 14.2 or 14.3 that is folded over to an outer circumferential surface of the corresponding first projection 17.1, 17.2 and 17.3 to the corresponding first projection 17.1, 17.2 and 17.3.

In addition, the cable harness 10 has a plastic body 21 which encloses the at least one electrically conductive plate 15 on the outside. In FIG. 5, it can be clearly seen that the outer circumferential surfaces of the respective first projections 17.1, 17.2 and 17.3 and in each case a region of the second projections 19.1, 19.2 and 19.3 protrude from the plastic body 21, i.e., are not enclosed by the plastic body 21 like the remaining part of the electrically conductive plate 15.

The conductor shields 14.1, 14.2 and 14.3 are electrically interconnected via the electrically conductive plate 15 of the exemplary cable harness 10. Via the—not depicted—fastener which can be accommodated in the respective fastening holes 18.1, 18.2 and 18.3, and which can also be electrically conductive and can be connected to the—not depicted—object, e.g., a housing, which can also be electrically conductive, shield currents routed via the respective conductor shields 14.1, 14.2 and 14.3 can be conducted to the object, which in turn may be earthed, for example, so that ultimately the shield conductors 14.1, 14.2 and 14.3 are also earthed.

In FIGS. 4 and 5, it is further depicted that the first projections 17.1, 17.2 and 17.3 are formed integrally with the electrically conductive plate 15. In addition, the second projections 19.1, 19.2 and 19.3 are also formed in one piece with the electrically conductive plate 15. In particular, the second projections 19.1, 19.2 and 19.3 are each designed in the form of a sleeve in the present case, without necessarily being limited thereto. In the present example, they form support sleeves which are inserted between the respective fastener and the object after the plate 15 has been fastened to the object and at the same time establish the electrical contact between the conductor shields 14.1, 14.2 and 14.3 via the plate 15 to the object, as indicated in FIG. 2 by way of example by way of a shield current 24 of the conductor 11.1.

In the exemplary embodiment of the cable harness 10 shown here, end side end faces of the respective sleeve-shaped second projections 19.1, 19.2 and 19.3 are substantially flush with a surface of the plastic body 21, in the example shown flush with a front 22 and a back 23 of the plastic body 21.

FIG. 3 schematically depicts a perspective sectional view through a component of a cable harness 30 according to a further embodiment of the disclosure. The main difference to the cable harness 10 from FIG. 1 is that instead of the single electrically conductive plate 15 of the cable harness 10, which combines the shield currents of all conductors 11.1, 11.2 and 11.3, the cable harness 30 in the present example has three electrically conductive plates 15.1, 15.2 and 15.3, each of which has one of the insertion holes 16.1, 16.2 and 16.3 including the respective first projections 17.1, 17.2 and 17.3 and one of the fastening holes 18.1, 18.2 and 18.3 including the respective second projections 19.1, 19.2 and 19.3. In this case, the individual shield currents 24 of the conductors 11.1, 11.2 and 11.3 are routed separately to the object via the respective plates 15.1, 15.2 and 15.3 and the corresponding second projections 19.1, 19.2 and 19.3.

In all other features, the cable harness 30 can be designed similarly or identically to the cable harness 10, without necessarily being limited thereto. Other combinations of the features disclosed herein are conceivable.

With reference to FIGS. 4 to 8, a method for manufacturing a cable harness, e.g., the cable harness 10, according to one embodiment of the disclosure is described below. FIGS. 4 to 8 each depict different process steps.

In particular, FIG. 4 depicts providing of the electrically conductive plate 15 of the cable harness 10. It should be understood that if the cable harness 30 is manufactured, the three separate electrically conductive plates 15.1, 15.2 and 15.3 are provided at this point.

In FIG. 5, the state after a further step of the method is depicted, in which the plate 15 (or the plurality of plates 15.1, 15.2, 15.3) is enclosed on the outside with a plastic material to form the plastic body 21, wherein the outer circumferential surfaces of the respective first projections 17.1, 17.2 and 17.3 and the regions of the respective second projections 19.1, 19.2 and 19.3 project from the plastic body 21.

In the depicted exemplary embodiment of the method, the plate 15 was overmolded with the plastic material to form the plastic body 21. However, the disclosure is not limited to overmolding with a plastic material. Other techniques which enclose the one or the plurality of plates 15 or 15.1, 15.2 and 15.3 with the plastic body 21 (e.g., insertion of the plate(s) into a liquid plastic mass and subsequent curing) are also encompassed by the disclosure.

FIG. 6 shows the manufacturing state in which the electrical conductors 11.1, 11.2 and 11.3 are provided and inserted into the respective insertion holes 16.1, 16.2 and 16.3 of the plate 15.

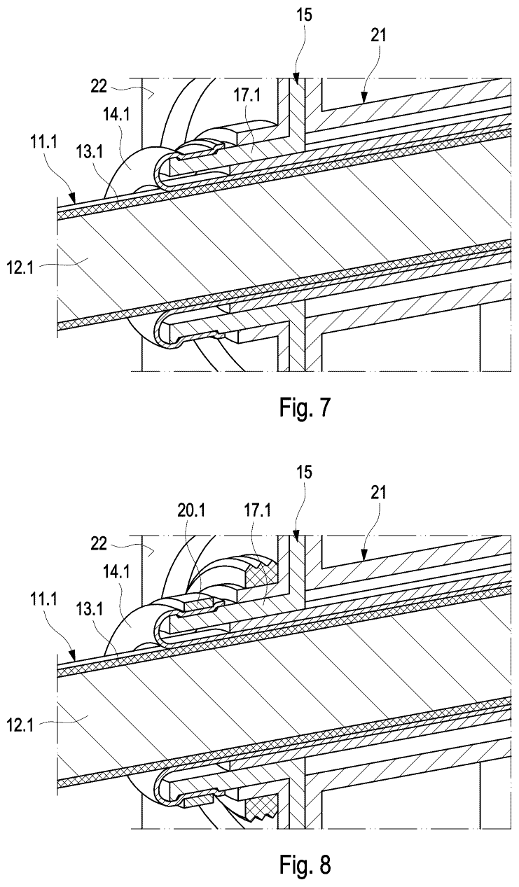

FIG. 7, which depicts a perspective sectional view along the first conductor 11.1, depicts an enlarged view of how a section of the conductor shield 14.1 is folded over towards the outer circumferential surface of the first projection 17.1. For example, the conductor shield 14.1 (e.g., a braid of a metal material) is turned around the first projection 17.1 by approximately 180°. This step is carried out in the same way for the other conductors 11.2 and 11.3.

In FIG. 8, which depicts the perspective longitudinal sectional view from FIG. 7 after a still further step of the method, it can be seen that the fastening element 20.1 has been provided and the section of the conductor shield 14.1 folded over towards the outer circumferential surface of the first projection 17.1 has been fastened to the first projection 17.1 in order to establish the electrical contact between the conductor shield 14.1 and the electrically conductive plate 15. In particular, in the depicted exemplary embodiment, the conductor shield 14.1 was fastened by crimping, without necessarily being limited to crimping.

In principle, the electrically conductive plate 15 or the electrically conductive plates 15.1, 15.2, 15.3 can be manufactured of any electrically conductive material. The material is not limited to metal materials. The specific electrical properties of the selected material enable the properties of the electrical contact to be defined in a targeted manner.

Furthermore, the diameters of the fastening holes 18.1, 18.2, 18.3 and the second projections 19.1, 19.2, 19.3 (e.g., support sleeves) can be adapted according to the desired electrical contacting properties and/or mechanical and/or geometric specifications.

German patent application no. 102025103093.6, filed Jan. 29, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A cable harness comprising:
at least one electrical conductor which has an electrically conductive core conductor;
an electrically non-conductive sheath surrounding the respective electrically conductive core conductor on an outer circumference thereof;
an electrically conductive conductor shield surrounding the electrically non-conductive sheath on an outer circumference thereof;
at least one electrically conductive plate which has at least one insertion hole through which the electrical conductor is routed;
a first projection which projects from an edge of the insertion hole;
at least one fastening hole for receiving a fastener by way of which the electrically conductive plate is able to be fastened to an object;
a second projection which projects from an edge of the fastening hole;
at least one fastening element which fastens a section of the electrically conductive conductor shield folded over to an outer circumferential surface of the first projection to the first projection; and
a plastic body which encloses the at least one electrically conductive plate on an outside thereof,
wherein the outer circumferential surface of the first projection and a region of the second projection protrude from the plastic body.

2. The cable harness according to claim 1, in which the first projection is formed integrally with the electrically conductive plate.

3. The cable harness according to claim 1, in which the second projection is formed integrally with the electrically conductive plate.

4. The cable harness according to claim 1, having a plurality of electrically conductive plates.

5. The cable harness according to claim 1, in which the second projection is designed in the form of a sleeve.

6. The cable harness according to claim 5, in which an end side end face of the sleeve-shaped second projection is flush with a surface of the plastic body.

7. A method for manufacturing a cable harness, comprising:
providing at least one electrical conductor which has an electrically conductive core conductor, an electrically non-conductive sheath surrounding the respective electrically conductive core conductor on an outer circumference thereof, and an electrically conductive conductor shield surrounding the electrically non-conductive sheath on an outer circumference thereof;
providing at least one electrically conductive plate which has at least one insertion hole, a first projection which projects from an edge of the insertion hole, at least one fastening hole for receiving a fastener by way of which the electrically conductive plate is able to be fastened to an object, and a second projection which projects from an edge of the fastening hole;
enclosing the at least one electrically conductive plate on an outside thereof with a plastic material to form a plastic body in such a way that an outer circumferential surface of the first projection and a region of the second projection protrude from the plastic body;
inserting the electrical conductor into the insertion hole;
folding a section of the conductor shield towards the outer circumferential surface of the first projection; and
providing at least one fastening element and fastening the section of the conductor shield folded over to the outer circumferential surface of the first projection to the first projection.

8. The method according to claim 7, in which the enclosing of the at least one electrically conductive plate with the plastic body comprises overmolding the electrically conductive plate with a plastic material.

9. The method according to claim 7, in which the electrically conductive conductor shield is fastened to the first projection by way of crimping.

10. The method according to claim 7, in which a plurality of electrical conductors, a plurality of fastening elements and a plurality of electrically conductive plates are provided, wherein the plurality of electrically conductive plates are jointly enclosed on the outside with the plastic material to form the plastic body, wherein one of the plurality of electrical conductors is inserted into the at least one insertion hole of each plate and the electrically conductive conductor shield of the respective electrical conductor is fastened to the corresponding first projection of the respective electrically conductive plate by way of at least one of the fastening elements.
